(19) United States
(12) Patent Application Publication
(10) Pub. No.: US 2024/0292069 A1
(43) Pub. Date: Aug. 29, 2024

(54) SYNTHESIZED REALISTIC METAHUMAN SHORT-FORM VIDEO

(71) Applicant: Loop Now Technologies, Inc., San Mateo, CA (US)

(72) Inventors: Hong-Ming Tseng, Toronto (CA); Edwin Chiu, Cupertino, CA (US); Wu-Hsi Li, Somerville, MA (US); Jeremiah Kevin Tu, Sunnyvale, CA (US)

(73) Assignee: Loop Now Technologies, Inc., San Mateo, CA (US)

(21) Appl. No.: 18/585,212

(22) Filed: Feb. 23, 2024

Related U.S. Application Data
(60) Provisional application No. 63/613,312, filed on Dec. 21, 2023.
(60) Provisional application No. 63/604,261, filed on Nov. 30, 2023.
(60) Provisional application No. 63/546,768, filed on Nov. 1, 2023.
(60) Provisional application No. 63/546,077, filed on Oct. 27, 2023.
(60) Provisional application No. 63/536,245, filed on Sep. 1, 2023.
(60) Provisional application No. 63/524,900, filed on Jul. 4, 2023.
(60) Provisional application No. 63/522,205, filed on Jun. 21, 2023.
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.

(51) Int. Cl. H04N 21/81; G06Q 30/0601; G06T 13/40; G06T 17/00; H04N 21/2187; H04N 21/234; H04N 21/254

(52) U.S. Cl. CPC H04N 21/816; G06Q 30/0643; G06T 13/40; G06T 17/00; H04N 21/2187; H04N 21/23424; H04N 21/2542

(57) ABSTRACT

Disclosed embodiments provide techniques for synthesized realistic metahuman short-form videos. A photorealistic representation of an individual is accessed from media sources including videos, photographs, livestreams, or a 360-degree recording of a human host. The individual can be selected based on information on the viewer of the short-form video, such as purchase history, viewing history, and metadata. The photorealistic representation is isolated using machine learning and is used to create a three-dimensional (3D) model of the individual, based on a game engine. A realistic synthetic performance is created by combining the 3D model of the individual with animation generated by a game engine. The synthesized performance can include the voice of the human host. The synthesized performance is inserted into a metaverse environment and rendered to a viewer as a short-form video, including an ecommerce window with an on-screen product card and virtual purchase cart.

### RELATED APPLICATIONS

This application claims the benefit of U.S. provisional patent applications “Synthesized Realistic Metahuman Short-Form Video” Ser. No. 63/447,925, filed Feb. 24, 2023, “Dynamic Synthetic Video Chat Agent Replacement” Ser. No. 63/447,918, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, and “Artificial Intelligence Virtual Assistant Using Large Language Model Processing” Ser. No. 63/613,312, filed Dec. 21, 2023.

Each of the foregoing applications is hereby incorporated by reference in its entirety.

### FIELD OF ART

This application relates generally to video analysis and more particularly to synthesized realistic metahuman short-form video.

### BACKGROUND

Every known human culture, past and present, has incorporated games of various forms into their societies. Games are formal versions of play that allow people to interact with both imagination and direct physical activity. Most games include an uncertainty of outcome, rules, a competition, a specific place and time, elements of fiction, change, goals, and personal enjoyment. Games also incorporate the worldviews of their cultures and help to pass them down to following generations. Some games incorporate religious and ethical lessons. Others can help to develop strategic thinking, mental elasticity, problem solving, and political and military abilities.

Some of the oldest games were made from pieces of bone, including versions of dice games that date back at least five thousand years. Versions of mancala, a two-player strategy board game, have been dated between 7000 BC and 9000 BC. Another early board game is senet, which is played by moving draftsmen on a board of 30 squares arranged into three parallel rows of 10 squares each. The players take turns moving their pieces based on the throw of dice, sticks, or bones. The goal is to reach the opposite edge of the board first. The game was first discovered in predynastic and first dynasty Egyptian burial sites. The Game of Twenty Squares dates to 2600 BC and has been discovered in archaeological digs from ancient Egypt, Babylon, and Chaldea. Later versions of the same game have been uncovered in Iran, Crete, Cyprus, Sri Lanka, and Syria. Roman and Byzantine cultures both had variants of the same board game. Shatranj, one of the oldest forms of chess, appears to have originated in Persia around 200 AD. Playing cards were invented in China in the 9^{th} century AD. Dominos appeared in China around the same time.

Physical games were also popular in many older cultures. Ancient Greece and Rome enjoyed ball games, polo, wrestling, and running competitions. Racing games were played on foot, on horseback, and on boats of various kinds. China developed early forms of football and golf. Indigenous North American peoples played various kinds of stickball games, which were like the modern version of lacrosse. There were sometimes major stickball events lasting several days which included participants from up to 1,000 men from opposing villages or tribes. European cultures played several different forms of lawn games, such as boules, lawn billiards, horseshoes, stoolball (an ancient form of cricket), and skittles.

Modern cultures incorporate games in many different forms. Modern chess rules were finalized in the 15^{th} century in Spain and Italy and spread throughout Europe and the Americas. Go and Shogi became the major board games played in Japan, and were played at a professional level in the 17^{th} century. Other board games such as Backgammon, Scrabble, and Risk are also played professionally with dedicated world championships. Commercial board games began to be widely manufactured and marketed in the 1800s, with Parcheesi, Snakes and Ladders (Chutes and Ladders in the United States), Geography, and The Mansion of Happiness becoming early favorites. Early wargaming developed into board game reenactments of historic battles, sometimes using miniature figures or simple cardboard pieces to represent various military units. These games eventually led to role-playing games such as Dungeons and Dragons, released in 1974. As home computers and gaming consoles became available, digital versions of many board games, outdoor games, and role-playing games were developed and marketed; games specifically tailored for the computer industry were also created. As computer technology progressed, the graphic design and sound quality of the games advanced in depth and sophistication. With the advent of virtual reality and augmented reality headsets, gaming will only continue to thrive and immerse the players in varied forms of entertainment well into the future.

### SUMMARY

Short-form videos are an increasingly important means of communication in advertising, education, entertainment, government, and business. As short-form videos become more sophisticated, the audiences, including buyers of goods and services, are becoming increasingly selective in their choices of message content, means of delivery, and deliverers of messages. Finding the best spokesperson for a short-form video can be a critical component to the success of marketing a product. Ecommerce consumers can be influenced to purchase products or services based on recommendations from trusted sources (like influencers) on various social networks. This influence can take place via posts from influencers and tastemakers, as well as friends and other connections within the social media systems. In many cases, influencers are paid for their efforts by website owners or advertising groups. The development of effective short-form videos in the promotion of goods and services is often a collaboration of professionally designed scripts and visual presentations distributed along with influencer and tastemaker content in various forms. Commercial presentations, such as livestream events, can combine pre-recorded, designed content with viewers and hosts. Demonstrations of products and services by video hosts can engage the viewers and increase the sales opportunities. By harnessing the power of machine learning and artificial intelligence (AI) game engines, media assets can be used to inform and promote products using the images, voices, and actions of influencers best suited to the viewing audience. Using the techniques of disclosed embodiments, it is possible to create effective and engaging content in pre-recorded and real-time collaborative events.

Disclosed embodiments provide techniques for synthesized realistic metahuman short-form videos. A photorealistic representation of an individual is accessed from media sources including videos, photographs, livestreams, or a 360-degree recording of a human host. The individual can be selected based on information on the viewer of the short-form video, such as purchase history, viewing history, and metadata. The photorealistic representation is isolated using machine learning and is used to create a three-dimensional (3D) model of the individual, based on a game engine. A realistic synthetic performance is created by combining the 3D model of the individual with animation generated by a game engine. The synthesized performance can include the voice of the human host. The synthesized performance is inserted into a metaverse environment and rendered to a viewer as a short-form video, including an ecommerce window with an on-screen product card and a virtual purchase cart.

A computer-implemented method for video analysis is disclosed comprising: accessing a photorealistic representation of a first individual from one or more media sources; isolating, using one or more processors, the photorealistic representation of the first individual from within the one or more media sources, wherein the isolating is accomplished by machine learning; creating a 3D model of the first individual, wherein the 3D model is based on a game engine; synthesizing a first performance, by the first individual that was modeled, wherein the first performance is based on animation using the game engine; and rendering, to a viewer, a first short-form video, wherein the first short-form video includes the first performance that was synthesized and an ecommerce environment. Some embodiments comprise inserting the first performance of the first individual in a metaverse representation. In embodiments, the isolating the photorealistic representation further comprises extracting physical information from the photorealistic representation of the first individual. In embodiments, the physical information includes facial features and/or body proportions.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a synthesized photorealistic short-form video.

FIG. 2 is a flow diagram for an ecommerce purchase within a synthesized photorealistic short-form video.

FIG. 3 is an infographic for a game engine synthesized video.

FIG. 4 is an infographic for recording a human host for a synthesized photorealistic short-form video.

FIG. 5 is an infographic for replacing a performance.

FIG. 6 is an example use of a synthesized photorealistic short-form video.

FIG. 7 illustrates an ecommerce purchase.

FIG. 8 is a system diagram for a synthesized photorealistic short-form video.

### DETAILED DESCRIPTION

Generating effective short-form video content can be a long and complicated process. Many commercial short-form videos require multiple rounds of recording and editing of video and audio content, blocking and directing action, writing and rewriting texts, and so on before an acceptable version is completed. Selecting the right narrator or host to be the spokesperson can be a critical component in the success of short-form videos, particularly in product promotions. Getting the right presenter can lead to increased market share and revenue.

Short-form videos with an engaging host highlighting and demonstrating products can be an effective way of engaging customers and promoting sales. They can form the foundation of livestream events as well as standalone advertisements or demonstrations of products and services. Artificial intelligence (AI) machine learning game engines can enable short-form videos to be used with voices, three-dimensional (3D) photorealistic models, and actions of influencers and spokespersons in real time, so that livestream events can be combinations of produced content, viewer interactions, and dynamic host presentations. The resulting short-form videos can also be recorded for use in other presentation formats, including metaverse environments, allowing the viewer a new level of engagement with realistic synthesized 3D video hosts as they watch, listen, and interact from their own unique perspectives.

Techniques for video analysis are disclosed. Based on information about the viewer, an individual can be selected as a host for a short-form video. Photorealistic representations of the selected individual can be accessed from one or more media sources, including videos, still images, livestream events, and livestream replays. The videos and still images can be obtained by recording the human host with video and still cameras, and microphones for audio recording. Using an AI machine learning process, the selected individual can be isolated within the video and photographic images. The isolated images can be used as input to a machine learning game engine to assemble a 3D model of the individual. The isolated images can include fine facial features, expressions, clothing, accessories, body proportions, and so on. The voice of the individual can be recorded and analyzed, using the machine learning game engine, for tone, pitch, inflection, diction, rhythm, etc. The 3D model of the individual can be used with the game engine to synthesize a host performance, combining the 3D model with animation generated by the game engine. The synthesized host performance can be rendered to the viewer as a short-form video. The synthesized host performance can also be inserted into a metaverse environment that the viewer can access. The host performance short-form video can include an ecommerce environment to allow purchases of highlighted items for sale.

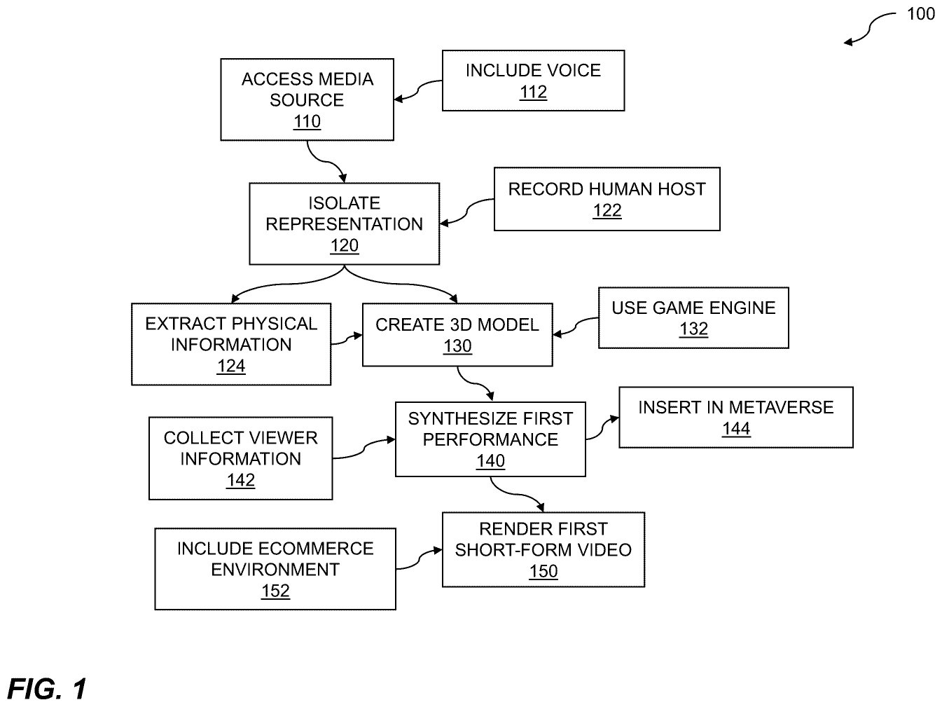

FIG. 1 is a flow diagram 100 for a synthesized photorealistic short-form video. The flow 100 includes accessing a photorealistic representation of a first individual from one or more media sources 110. In embodiments, the media sources 110 can include one or more photographs, videos, livestream events, and livestream replays, including the voice 112 of the first individual. In some embodiments, the photorealistic representation can include a 360-degree representation of the first individual. The first individual can comprise a human host that can be recorded 122 with one or more cameras, including videos and still images, and microphones for voice recording. The recordings 122 can include one or more angles of the human host and can be combined to comprise a dynamic 360-degree photorealistic representation of the human host. The voice 112 of the human host can be recorded and included in the representation of the human host.

The flow 100 includes isolating, using one or more processors, the photorealistic representation 120 of the first individual from within the one or more media sources, wherein the isolating is accomplished by machine learning. In embodiments, the media sources can include photographs, videos, livestream events, livestream replays, and recordings of a human host. The media sources can include the voice of the first individual. The isolating of the photorealistic representation 120 by machine learning can be accomplished by training a convolutional neural network (CNN) to recognize and classify images of people. As images are processed by the CNN, they are first converted into signal data and normalized. The images are then passed through a series of algorithms that filter and separate out unnecessary objects, such as background and non-human objects. This process is called segmentation. The CNN will then detect features in the remaining human image, such as facial features and body proportions, and classify them. Once the images have been classified, the CNN will assign them to specific categories. Thus, physical information of the first individual can be extracted 124 and used to create a 3D model 130 of the individual.

The flow 100 includes creating a 3D model 130 of the first individual, wherein the 3D model is based on a game engine 132. A game engine 132 is a set of software applications that work together to create a framework for users to build and create video games. They can be used to render graphics, generate and manipulate sound, create and modify physics within the game environment, detect collisions, manage computer memory, and so on. In embodiments, the isolated and categorized photorealistic images of the first individual can be used as input to a machine learning game engine that can build a detailed 3D model 130 of the individual, including the voice of the individual extracted from the video and livestream recordings. The game engine 132 can include a Character Movement Component that provides common modes of movement for 3D humanoid characters including walking, falling, swimming, crawling, and so on. These default movement modes are built to replicate by default and can be modified to create customized movements, such as skiing, scuba diving, or demonstrating a product. Facial features can be edited to appear more lifelike, including storing unique and idiosyncratic elements of a human face. Articles of clothing can be similarly edited to perform as they do in real life. Lighting presets can be used to place individual characters in photorealistic environments so that light sources, qualities, and shadows appear lifelike. Voice recordings can be used to generate dialogue with the same vocal qualities as the first individual. Volume, pitch, rhythm, frequency, and so on can be manipulated within the game engine to create realistic dialogue for the 3D model 130 of the first individual.

The flow 100 includes synthesizing a first performance 140, by the first individual that was modeled, wherein the first performance is based on animation using the game engine 132. In embodiments, a game engine can be used to generate a series of animated movements, including basic actions such as sitting, standing, holding a product, presenting a video or photograph, describing an event, and so on. Specialized movements can be programmed and added to the animation as needed. Dialogue can be added so that the face of the presenter moves appropriately as the words are spoken. The 3D model 130 of the host individual can be used as the performer of the animation after the sequence of movements and dialogues have been decided. The result is a synthesized performance 140 by the selected host model, combining the animation generated by the game engine and the 3D model of the individual, including the voice of the individual.

The synthesized host performance 140 can be inserted into a metaverse environment 144. A metaverse is a virtual-reality space in which users can interact with a computer-generated environment and other users. It is accessed via the Internet using virtual reality (VR) and augmented reality (AR) technologies that can be used to give a user a sense of virtual presence within the metaverse environment. Computer-generated images of objects, people, animals, buildings, backgrounds, and so on can be placed in the metaverse environment. Sounds can be recorded and projected into the metaverse environment as well, so that a user with a VR headset can see, hear, and speak to others within the metaverse environment. The VR headset allows 3D viewing and stereo sound so that the user experience is immersive. The synthesized host performance 140 can be inserted into a metaverse environment, or virtual space 144, so that a viewer with a VR headset can see and hear the host performance in a virtual 3D environment. The viewer can move around the synthesized host as the performance is played, seeing it from different angles, and so on.

The flow 100 includes collecting viewer information 142 that can be used to select a first individual for the synthesized host performance. In embodiments, viewer information 142 can include purchase history, view history, and metadata from one or more websites, social media platforms, and metaverse environments. The viewer information can be analyzed by an AI machine learning model and used to select a first individual that can appeal to the viewer to encourage further engagement and the purchase of highlighted items for sale in the synthesized short-form video.

The flow 100 includes rendering, to a viewer, a first short-form video 150, wherein the first short-form video includes the first performance that was synthesized and an ecommerce environment 152. In embodiments, the machine learning game engine can be used to record a short-form video 150 and play it for a viewer in a livestream event, on a social media platform, from a web page, etc. An ecommerce environment can be rendered to include a virtual purchase cart and on-screen product cards as part of the short-form video. A device used to view the rendered synthetic host short-form video can be an Over-the-Top (OTT) device such as a mobile phone, laptop computer, tablet, pad, or desktop computer, etc. The viewing of the short-form video can be accomplished using a browser or another application running on the device. A product card can be generated and rendered on the device for viewing the short-form video. In embodiments, the product card represents at least one product available for purchase on the website or social media platform hosting the short-form video or highlighted during the short-form video. Embodiments can include inserting a representation of a product for sale into the on-screen product card. A product card is a graphical element such as an icon, thumbnail picture, thumbnail video, symbol, or another suitable element that is displayed in front of the video. The product card is selectable via a user interface action such as a press, swipe, gesture, mouse click, verbal utterance, or some other suitable user action. When the product card is invoked, an in-frame shopping environment can be rendered over a portion of the short-form while the chat continues to play. This rendering enables an ecommerce purchase by a user while preserving a short-form video session. In other words, the user is not redirected to another site or portal that causes the short-form video to stop. Thus, viewers can initiate and complete a purchase completely inside of the short-form video user interface, without being directed away from the currently playing video. Allowing the short-form video to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

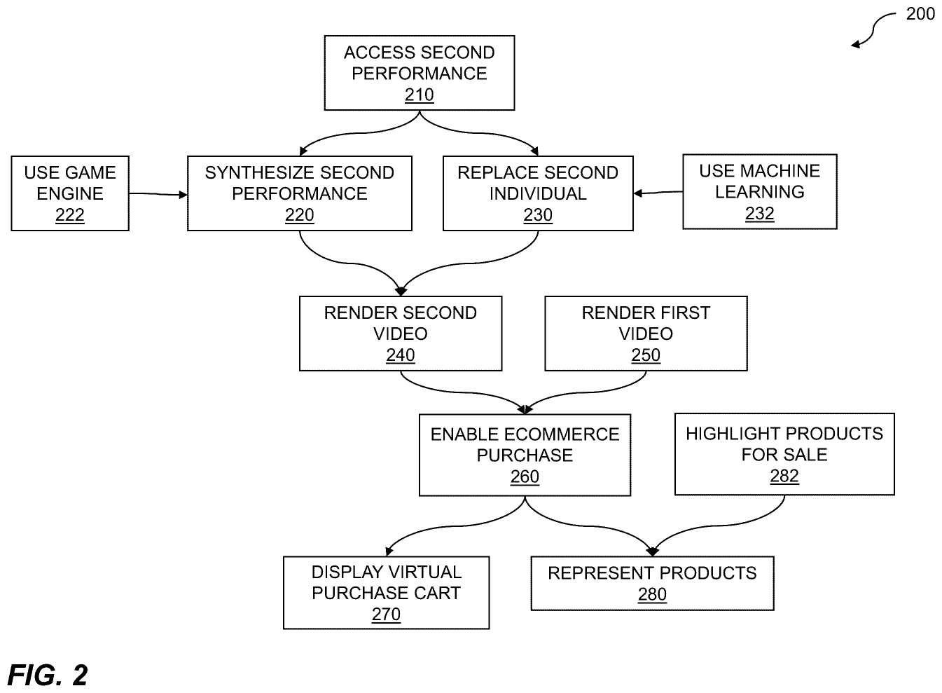

FIG. 2 is a flow diagram 200 for an ecommerce purchase within a synthesized photorealistic short-form video. A second performance by a second individual can be accessed, based on information about the viewer. The second individual can be selected as a host for a second short-form video. Photorealistic representations of the second individual can be accessed from one or more media sources, including videos, still images, livestream events, and livestream replays. The videos and still images can be obtained by recording a second human host with video and still cameras, and microphones for audio recording. Using an AI machine learning process, the second individual can be isolated within the video and photographic images. The isolated images can be used as input to a machine learning game engine to assemble a 3D model of the individual. The isolated images can include fine facial features, expressions, clothing, accessories, body proportions, and so on. The voice of the second individual can be recorded and analyzed, using the machine learning game engine, for tone, pitch, inflection, diction, rhythm, etc. The 3D model of the second individual can be used with the game engine to synthesize a second host performance, combining the 3D model with animation generated by the game engine. The second synthesized host performance can be rendered to the viewer as a short-form video. The second synthesized host performance can also be inserted into a metaverse environment that the viewer can access. The second host performance short-form video can include an ecommerce environment to allow purchases of highlighted items for sale.

The second individual performance can be replaced with the first individual using an AI machine learning model. The AI model can be used to combine the 3D model of the first individual with the performance of the second individual to create a synthetic host performance so that the image and voice of the first individual replaces the second individual. The resulting synthetic first individual host performance can be customized to include information about products for sale, product use, additional education options, etc.

The flow 200 includes accessing a second performance 210 by a second individual. In embodiments, information about the viewer can be used to select the second individual. The viewer information can include purchase history, view history, and metadata from one or more websites, social media platforms, and metaverse environments. The viewer information can be analyzed by an AI machine learning model and used to select a second individual that can appeal to the viewer to encourage further engagement and the purchase of highlighted items for sale in the synthesized short-form video. Accessing a second performance 210 of a second individual can be accomplished using one or more media sources. In embodiments, the media sources can include one or more photographs, videos, livestream events, and livestream replays, including the voice of the second individual. In some embodiments, a photorealistic representation can include a 360-degree representation of the second individual.

The flow 200 includes isolating, using one or more processors, the photorealistic representation of the second individual from within the one or more media sources, wherein the isolating is accomplished by machine learning. In embodiments, the media sources can include photographs, videos, livestream events, livestream replays, and recordings of a human host. The media sources can include the voice of the first individual. The isolating of the photorealistic representation by machine learning can be accomplished by training a convolutional neural network (CNN) to recognize and classify images of people. As images are processed by the CNN, they are first converted into signal data and normalized. The images are then passed through a series of algorithms that filter and separate out unnecessary objects, such as background and non-human objects. This process is called segmentation. The CNN will then detect features in the remaining human image, such as facial features and body proportions, and classify them. Once the images have been classified, the CNN will assign them to specific categories. Thus, physical information of the second individual can be extracted and used to create a 3D model of the second individual.

The flow 200 includes creating a 3D model of the second individual, wherein the 3D model is based on a game engine 222. A game engine 222 is a set of software applications that work together to create a framework for users to build and create video games. The software applications can be used to render graphics, generate and manipulate sound, create and modify physics within the game environment, detect collisions, manage computer memory, and so on. In embodiments, the isolated and categorized photorealistic images of the second individual can be used as input to a machine learning game engine 222 that can build a detailed 3D model of the individual, including the voice of the individual extracted from the video and livestream recordings. The game engine 222 can include a Character Movement Component that provides common modes of movement for 3D humanoid characters including walking, falling, swimming, crawling, and so on. These default movement modes are built to replicate by default and can be modified to create customized movements, such as skiing, scuba diving, or demonstrating a product.

The flow 200 includes synthesizing the second performance 220 by the second individual, wherein the synthesizing is based on the game engine 222. In embodiments, a game engine 222 can be used to generate a series of animated movements, including basic actions such as sitting, standing, holding a product, presenting a video or photograph, describing an event, and so on. Specialized movements can be programmed and added to the animation as needed. Dialogue can be added so that the face of the presenter moves appropriately as the words are spoken. The 3D model of the second host individual can be used as the performer of the animation after the sequence of movements and dialogues have been decided. The result is a synthesized performance 220 by the second host model, combining the animation generated by the game engine and the 3D model of the individual, including the voice of the individual.

The flow 200 includes rendering a second short-form video 240 based on the second performance by the second individual, wherein the second short-form video includes the ecommerce environment. In embodiments, the machine learning game engine can be used to generate and render a second short-form video 240 and play it for a viewer in a livestream event, on a social media platform, from a web page, etc. An ecommerce environment can be rendered to include a virtual purchase cart 270 and on-screen product cards as part of the short-form video. In embodiments, the product cards represent at least one product available for purchase on the website or social media platform hosting the short-form video or highlighted during the short-form video. Embodiments can include inserting a representation of a product for sale 280 into the on-screen product card. In embodiments, the rendering of the first short-form video can include stitching the short-form video into a livestream or livestream replay. In further embodiments, the second short-form video is stitched into a livestream or livestream replay.

The flow 200 includes replacing, in the second performance, the second individual 230 with the first individual, wherein the replacing is accomplished using machine learning 232. In embodiments, the replacing can be used to produce a synthesized short-form video that can include a synthesized 3D version of the first individual. Synthesized videos are created using a generative model. Generative models are a class of statistical models that can generate new data instances. The generative model can include a generative adversarial network (GAN). A generative adversarial network (GAN) includes two parts. A generator learns to generate plausible data. The generator can be a game engine 222. The generated instances are input to a discriminator. The discriminator learns to distinguish the generator's fake data from real data. The discriminator penalizes the generator for generating implausible results. During the training process, over time, the output of the generator improves, and the discriminator has less success distinguishing real output from fake output. The generator and discriminator can be implemented as neural networks, with the output of the generator connected to the input of the discriminator. Embodiments may utilize backpropagation to create a signal that the generator neural network uses to update its weights.

The discriminator may use training data coming from two sources, real data, which can include images of real objects (the performance of the second individual, objects, etc.), and fake data, which are 3D images created by the game engine 222. The discriminator uses the fake data as negative examples during the training process. A discriminator loss function is used to update weights via backpropagation for discriminator loss when it misclassifies an image. The generator learns to create fake data by incorporating feedback from the discriminator. Essentially, the generator learns how to “trick” the discriminator into classifying its output as real. A generator loss function is used to penalize the generator for failing to trick the discriminator. Thus, in embodiments, the generative adversarial network (GAN) includes two separately trained networks. The discriminator neural network can be trained first, followed by training the generative neural network, until a desired level of convergence is achieved. In embodiments, multiple images of a first individual may be used to create a second short-form video that replaces the second individual's performance in the short-form video with a performance by the synthesized photorealistic 3D first individual.

The flow 200 includes rendering a second short-form video based on the second performance by the first individual, wherein the second short-form video includes an ecommerce environment 260. In embodiments, an AI machine learning model 232 can be used to generate and render a synthesized photorealistic short-form video using the 3D model of the first individual from the first video 250 and play it for a viewer in a livestream event, on a social media platform, from a web page, etc. The ecommerce environment 260 can be rendered to include a virtual purchase cart 270 and on-screen product cards as part of the short-form video. In embodiments, the product cards represent at least one product available for purchase on the website or social media platform hosting the short-form video or highlighted during the short-form video. Embodiments can include inserting a representation of a product for sale 280 into the on-screen product card.

The flow 200 includes enabling ecommerce purchases 260. In embodiments, the ecommerce enabling environment can include one or more products for sale based on the information on the viewer. The synthesized host performance in the short-form video can highlight the one or more products for sale 282 for the viewer. In embodiments, the enabling of an ecommerce environment can include displaying a virtual purchase cart 270 that supports checkout of virtual cart contents, including specifying various payment methods, and application of coupons and/or promotional codes. In some embodiments, the payment methods can include fiat currencies such as United States dollar (USD), as well as virtual currencies, including cryptocurrencies such as Bitcoin. In some embodiments, more than one object (product) can be highlighted and enabled for ecommerce purchase. In embodiments, when multiple items are purchased via product cards during the rendering of the short-form video, the purchases are cached until termination of the video, at which point the orders are processed as a batch. The termination of the video can include the user stopping playback, the user exiting the video window, the livestream ending, or a prerecorded video ending. The batch order process can enable a more efficient use of computer resources, such as network bandwidth, by processing the orders together as a batch instead of processing each order individually.

The ecommerce environment can include an on-screen product card representing the one or more products 280 for sale. In embodiments, the product card represents at least one product available for purchase while the synthesized short-form video plays. Embodiments can include inserting a representation of an object for sale into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. The product card can be inserted while the short-form video, including a synthetic host performance, is visible on a viewing device. When the product card is invoked, an in-frame shopping environment is rendered over a portion of the short-form video while the video continues to play. This rendering enables an ecommerce purchase by a user while preserving a continuous short-form video session. In other words, the user is not redirected to another site or portal that causes the short-form video to stop. Thus, viewers can initiate and complete a purchase completely inside of the short-form video user interface, without being directed away from the video. Allowing the synthesized short-form video to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

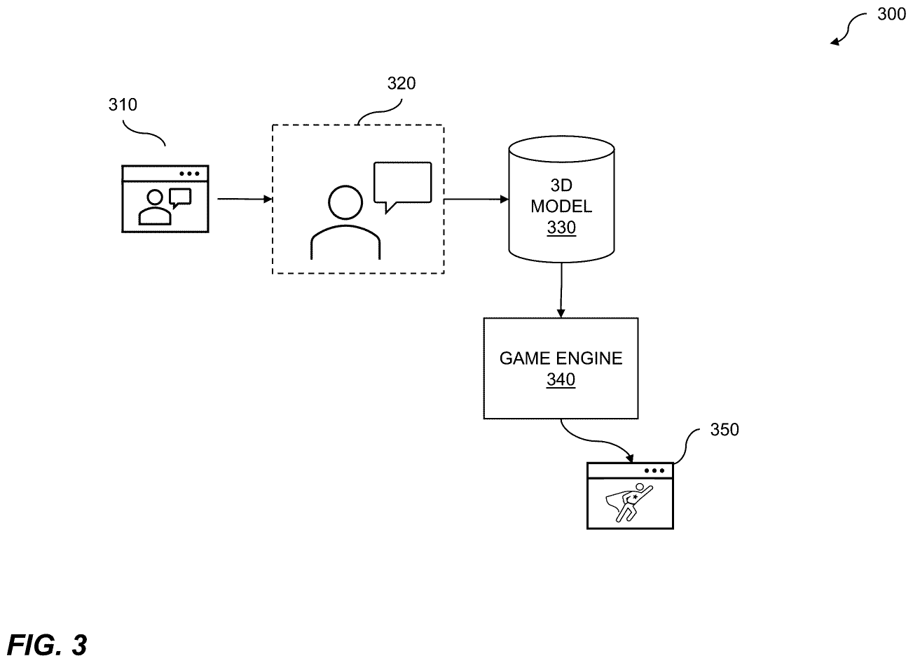

FIG. 3 is an infographic for a game engine synthesized video. The infographic 300 includes accessing a photorealistic representation of a first individual 310 from one or more media sources. In embodiments, viewer information can be collected that can be used to select a first individual for the synthesized host performance. The viewer information can include purchase history, view history, and metadata from one or more websites, social media platforms, and metaverse environments, including the website and metaverse hosting the viewing of the synthesized short-form video. The viewer information can be analyzed by an AI machine learning model and used to select a first individual that can appeal to the viewer to encourage further engagement and the purchase of highlighted items for sale in the synthesized short-form video.

In embodiments, the media sources can include one or more photographs, videos, livestream events, and livestream replays, including the voice of the first individual. In some embodiments, the photorealistic representation can include a 360-degree representation of the first individual. The first individual can comprise a human host that can be recorded with one or more cameras, including videos and still images, and microphones for voice recording. The recordings can include one or more angles of the human host and can be combined to comprise a dynamic 360-degree photorealistic representation of the human host. The voice of the human host can be recorded and included in the representation of the human host.

The infographic 300 includes isolating 320, using one or more processors, the photorealistic representation of the first individual from within the one or more media sources, wherein the isolating is accomplished by machine learning. In embodiments, the media sources can include photographs, videos, livestream events, livestream replays, and recordings of a human host. The media sources can include the voice of the first individual. The isolating of the photorealistic representation by machine learning can be accomplished by training a convolutional neural network (CNN) to recognize and classify images. As images are processed by the CNN, they are first converted into signal data and normalized. The images are then passed through a series of algorithms that filter and separate out unnecessary objects, such as background and non-human objects. This process is called segmentation. The CNN will then detect features in the remaining human image, such as facial features and body proportions, and classify them. Once the images have been classified, the CNN will assign them to specific categories. Thus, detailed physical information of the first individual can be extracted, categorized, and used to create a 3D model of the individual.

The infographic 300 includes creating a 3D model 330 of the first individual, wherein the 3D model is based on a game engine 340. As mentioned above and throughout, a game engine 340 is a set of software applications that work together to create a framework for developers to build and create video games. They can be used to render graphics, generate and manipulate sound, create and modify physics within the game environment, detect collisions, manage computer memory, and so on. Game engines are designed to be modular, so that additional software can be added to the game engine framework to address specific tasks or augment specific design aspects, such as matching a human voice or managing clothing and accessory design and movement. In embodiments, the isolated and categorized photorealistic images of the first individual can be used as input to a machine learning game engine that can build a detailed 3D model 330 of the individual, including the voice of the individual extracted from the video and livestream recordings. The game engine 340 can include a Character Movement Component that provides common modes of movement for 3D humanoid characters including walking, falling, swimming, crawling, and so on. These default movement modes are built to replicate by default and can be modified to create customized movements, such as skiing, skydiving, or riding a motorcycle, as part of a product demonstration. Facial features can be edited to appear more lifelike, including storing unique and idiosyncratic elements of a human face. Articles of clothing can be similarly edited to perform as they do in real life. Lighting presets can be used to place individual characters in photorealistic environments so that light sources, qualities, and shadows appear lifelike. Voice recordings can be used to generate dialogue with the same vocal qualities as the first individual. Volume, pitch, rhythm, frequency, and so on can be manipulated within the game engine to create realistic dialogue for the 3D model of the first individual.

The infographic 300 includes synthesizing a first performance, by the first individual that was modeled, wherein the first performance is based on animation using the game engine 340. In embodiments, a game engine 340 can be used to generate a series of animated movements, including basic actions such as sitting, standing, holding a product, presenting a video or photograph, describing an event, and so on. Specialized movements can be programmed and added to the animation as needed. Dialogue can be added so that the face of the presenter moves appropriately as the words are spoken. The 3D model 330 of the first individual can be used as the performer of the animation after the sequence of movements and dialogues have been decided. The result is a synthesized photorealistic performance by the selected first individual, combining the animation generated by the game engine 340 and the 3D model of the individual 330, including the voice of the individual. The synthesized performance can be generated as a short-form video 350 to be rendered directly to a webpage or social media platform or stored to be viewed later.

The infographic 300 includes rendering, to a viewer, a first short-form video 350, wherein the first short-form video includes the first performance that was synthesized and an ecommerce environment. In embodiments, the machine learning game engine 340 can be used to generate a short-form video 350 and play it for a viewer in a livestream event, on a social media platform, from a web page, etc. An ecommerce environment can be rendered to include a virtual purchase cart and on-screen product cards as part of the short-form video. A device used to view the rendered synthetic host short-form video 350 can be an Over-the-Top (OTT) device such as a mobile phone, laptop computer, tablet, pad, or desktop computer, etc. The viewing of the short-form video can be accomplished using a browser or another application running on the device. A product card can be generated and rendered on the device used to view the short-form video. In embodiments, the product card represents at least one product available for purchase on the website or social media platform hosting the short-form video or highlighted during the short-form video. Embodiments can include inserting a representation of a product for sale into the on-screen product card. Viewers can initiate and complete a purchase completely inside of the short-form video user interface, without being directed away from the currently playing video.

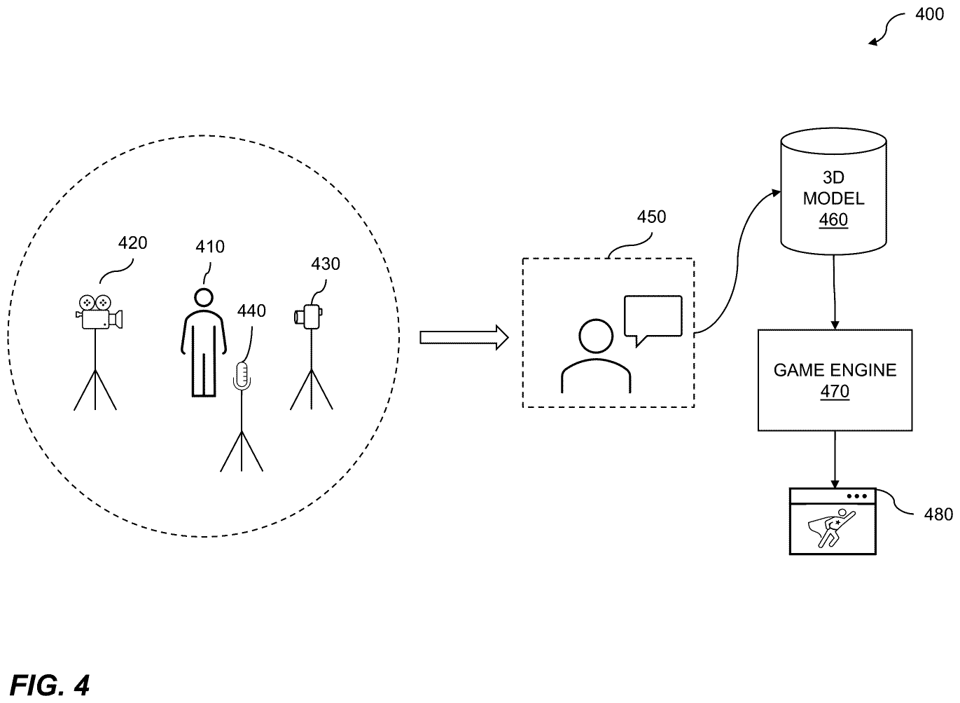

FIG. 4 is an infographic for recording a human host for a synthesized photorealistic short-form video. The infographic 400 includes a human host 410 selected based on information collected on the viewer. In embodiments, the viewer information can include purchase history, view history, and metadata from one or more websites, social media platforms, and metaverse environments. The viewer information can be analyzed by an AI machine learning model and used to select a first individual that can appeal to the viewer, and to encourage further engagement and the purchase of highlighted items for sale in the synthesized short-form video.

The infographic 400 includes one or more video cameras 420, one or more still photograph cameras 430, and one or more audio microphones 440 for recording images and the voice of a human host 410. Still 3D or stereo cameras use at least two lenses to record multiple points of view. In some embodiments, one lens moves position to record the same object in multiple positions. Professional digital cameras can record images with resolutions of up to 61 megapixels (MPs). This means that the width of an image measures 9,504 pixels and the height measures 6,336 pixels. Multiplying the height by the width yields a result of just over 61 million pixels. Most 3D still cameras operate with resolutions between 10 MP and 25 MP. 3D video cameras work in a similar way to still cameras, with multiple lenses used to generate stereoscopic images. Resolutions for video cameras are lower than still photography cameras, with the majority operating at the 10 MP range. The frame rates can be set from 24 frames per second, which is the standard used for commercial television and movies, to 60 frames per second, which can be used for slow motion photography. Many 3D video cameras can also record sound as well. 3D scanner manufacturers also produce 3D full body scanning booths that can generate a complete 3D scan in approximately five minutes.

The infographic 400 includes isolating the images of the human host 410 generated by the video 420 and still photograph 430 cameras. In embodiments, the isolating 450 of the photorealistic representation can be accomplished by training a machine learning convolutional neural network (CNN) to recognize and classify images of people. As images are processed by the CNN, they are first converted into signal data and normalized. The images are then passed through a series of algorithms that filter and separate out unnecessary objects, such as background and non-human objects. This process is called segmentation. The CNN will then detect features in the remaining human image, such as facial features and body proportions, and classify them. Once the images have been classified, the CNN will assign them to specific categories. Thus, physical information of the human host can be extracted and used to create a 3D model 460 of the individual.

The infographic 400 includes creating a 3D model 460 of the human host, wherein the 3D model is based on a game engine 470. As mentioned above and throughout, a game engine is a set of software applications that work together to create a framework for developers to build and create video games. They can be used to render graphics, generate and manipulate sound, create and modify physics within the game environment, detect collisions, manage computer memory, and so on. Game engines are designed to be modular, so that additional software can be added to the game engine framework to address specific tasks or to augment specific design aspects, such as matching a human voice or managing clothing and accessory design and movement. In embodiments, the isolated and categorized photorealistic images of the human host 410 can be used as input to a machine learning game engine 470 that can build a detailed 3D model 460 of the individual, including the voice of the individual extracted from the video and livestream recordings. The game engine 470 can include a Character Movement Component that provides common modes of movement for 3D humanoid characters including walking, falling, swimming, crawling, and so on. These default movement modes are built to replicate by default and can be modified to create customized movements, such as skiing, skydiving, or riding a motorcycle, as part of a product demonstration. Facial features can be edited to appear more lifelike, including storing unique and idiosyncratic elements of a human face. Articles of clothing can be similarly edited to perform as they do in real life. Lighting presets can be used to place individual characters in photorealistic environments so that light sources, qualities, and shadows appear lifelike. Voice recordings can be used to generate dialogue with the same vocal qualities as the first individual. Volume, pitch, rhythm, frequency, and so on can be manipulated within the game engine to create realistic dialogue for the 3D model of the first individual.

The infographic 400 includes synthesizing a performance, by the human host 410, wherein the performance is based on animation using the game engine 470. In embodiments, a game engine 470 can be used to generate a series of animated movements, including basic actions such as sitting, standing, holding a product, presenting a video or photograph, describing an event, and so on. Specialized movements can be programmed and added to the animation as needed. Dialogue can be added so that the face of the presenter moves appropriately as the words are spoken. The 3D model of the first individual can be used as the performer of the animation after the sequence of movements and dialogues have been decided. The result is a synthesized photorealistic performance by the human host, combining the animation generated by the game engine 470 and the 3D model of the individual, including the voice of the individual. The synthesized performance can be generated as a short-form video 480 to be rendered directly to a webpage or social media platform, or stored to be viewed later.

The infographic 400 includes rendering, to a viewer, a short-form video 480, wherein the short-form video includes the performance that was synthesized and an ecommerce environment. In embodiments, the machine learning game engine 470 can be used to generate a short-form video 480 and play it for a viewer in a livestream event, on a social media platform, from a web page, etc. An ecommerce environment can be rendered to include a virtual purchase cart and on-screen product cards as part of the short-form video. A device used to view the rendered synthetic host short-form video 480 can be an Over-the-Top (OTT) device such as a mobile phone, laptop computer, tablet, pad, or desktop computer, etc. The viewing of the short-form video can be accomplished using a browser or another application running on the device. A product card can be generated and rendered on the device used to view the short-form video. In embodiments, the product card represents at least one product available for purchase on the website or social media platform hosting the short-form video or highlighted during the short-form video. Embodiments can include inserting a representation of a product for sale into the on-screen product card. Viewers can initiate and complete a purchase completely inside of the short-form video user interface, without being directed away from the currently playing video.

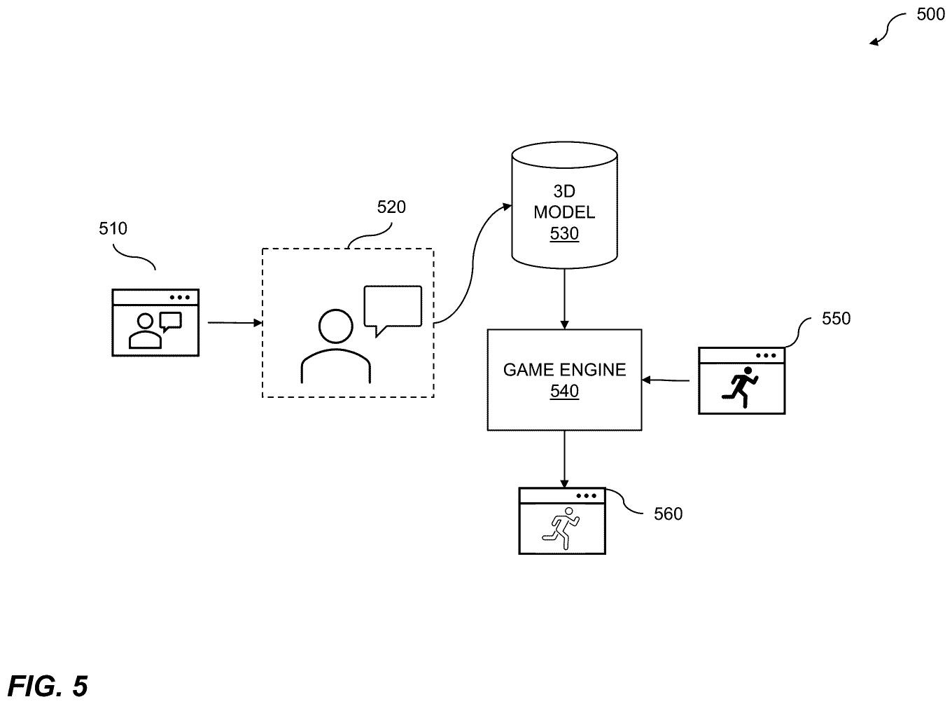

FIG. 5 is an infographic for replacing a performance. The infographic 500 includes a video performance by a second individual 510 selected based on information collected on the viewer. In embodiments, the viewer information can include purchase history, view history, and metadata from one or more websites, social media platforms, and metaverse environments. The viewer information can be analyzed by an AI machine learning model and used to select a video performance that can appeal to the viewer to encourage further engagement and the purchase of highlighted items for sale in the synthesized short-form video. In embodiments, the media sources can include one or more videos, livestream events, and livestream replays.

The infographic 500 includes isolating 520, using one or more processors, the photorealistic representation of the second individual 510 from within the one or more media sources, wherein the isolating is accomplished by machine learning. In embodiments, the media sources can include photographs, videos, livestream events, livestream replays, and recordings of a second individual. The media sources can include the voice of the second individual. The isolating of the photorealistic representation 520 by machine learning can be accomplished by training a convolutional neural network (CNN) to recognize and classify images. As images are processed by the CNN, they are first converted into signal data and normalized. The images are then passed through a series of algorithms that filter and separate out unnecessary objects, such as background and non-human objects. This process is called segmentation. The CNN will then detect features in the remaining human image, such as facial features and body proportions, and classify them. Once the images have been classified, the CNN will assign them to specific categories. Thus, detailed physical information of the first individual can be extracted, categorized, and used to create a 3D model 530 of the second individual.

The infographic 500 includes creating a 3D model 530 of the second individual, wherein the 3D model is based on a game engine 540. A game engine 540 is a set of software applications that work together to create a framework for developers to build and create video games. They can be used to render graphics, generate and manipulate sound, create and modify physics within the game environment, detect collisions, manage computer memory, and so on. Game engines are designed to be modular, so that additional software can be added to the game engine framework to address specific tasks or to augment specific design aspects, such as matching a human voice or managing clothing and accessory design and movement. In embodiments, the isolated and categorized photorealistic images of the second individual can be used as input to a machine learning game engine that can build a detailed 3D model of the individual, including the voice of the individual extracted from the video and livestream recordings. The game engine 540 can include a Character Movement Component that provides common modes of movement for 3D humanoid characters, including walking, falling, swimming, crawling, and so on. These default movement modes are built to replicate by default and can be modified to create customized movements, such as skiing, skydiving, or riding a motorcycle, as part of a product demonstration. Facial features can be edited to appear more lifelike, including storing unique and idiosyncratic elements of a human face. Articles of clothing can be similarly edited to perform as they do in real life. Lighting presets can be used to place individual characters in photorealistic environments so that light sources, qualities, and shadows appear lifelike. Voice recordings can be used to generate dialogue with the same vocal qualities as the first individual. Volume, pitch, rhythm, frequency, and so on can be manipulated within the game engine to create realistic dialogue for the 3D model of the second individual.

The infographic 500 includes synthesizing a performance, by a first individual 550, wherein the synthesized performance is based on the performance of the second individual 510 and animation using the game engine 540. In embodiments, a game engine 540 can be used to generate a series of animated movements, including basic actions such as sitting, standing, holding a product, presenting a video or photograph, describing an event, and so on. Specialized movements can be programmed and added to the animation as needed. Dialogue can be added so that the face of the presenter moves appropriately as the words are spoken. The animated movements and dialogue can be added to the extracted video performance of the second individual. A 3D model 530 of the first individual, created in the same manner as the 3D model of the second individual, can be used as the performer of the game engine animation and the performance of the second individual. The result is a synthesized photorealistic performance by the first individual, combining the animation generated by the game engine, the performance of the second individual, and the 3D model of the first individual, including the voice of the first individual. The synthesized performance can be generated as a short-form video 560 to be rendered directly to a webpage or social media platform or stored to be viewed later. The user of the 3D model and game engine can use any stored photorealistic 3D human model as the performer of isolated short-form video content 510, animation generated by the game engine 540, or a combination of both. The ability to dynamically select photorealistic 3D host performers gives the user a significant advantage in control of content and enhances the ability to create and render effective messaging to the viewer. The viewer engagement and the likelihood of sales of goods and services highlighted by the host performers can be increased by this process. In embodiments, a video including an animation of a person from the game engine can drive a static image of a host from a livestream video into a new movie clip. The new movie clip that the host will animate and his or her movement can be based on the video clip from the game engine.

The infographic 500 includes rendering, to a viewer, a short-form video 560, wherein the short-form video includes the performance that was synthesized and an ecommerce environment. In embodiments, the machine learning game engine 540 and the video performance of a second individual 510 can be used to generate a short-form video 560 and can be combined with a photorealistic 3D human model 530 and played for a viewer in a livestream event, on a social media platform, from a web page, etc. An ecommerce environment can be rendered to include a virtual purchase cart and on-screen product cards as part of the short-form video. A device used to view the rendered synthetic host short-form video 560 can be an Over-the-Top (OTT) device such as a mobile phone, laptop computer, tablet, pad, or desktop computer, etc. The viewing of the short-form video can be accomplished using a browser or another application running on the device. A product card can be generated and rendered on the device used to view the short-form video. In embodiments, the product card represents at least one product available for purchase on the website or social media platform hosting the short-form video or highlighted during the short-form video. Embodiments can include inserting a representation of a product for sale into the on-screen product card. Viewers can initiate and complete a purchase completely inside of the short-form video user interface, without being directed away from the currently playing video.

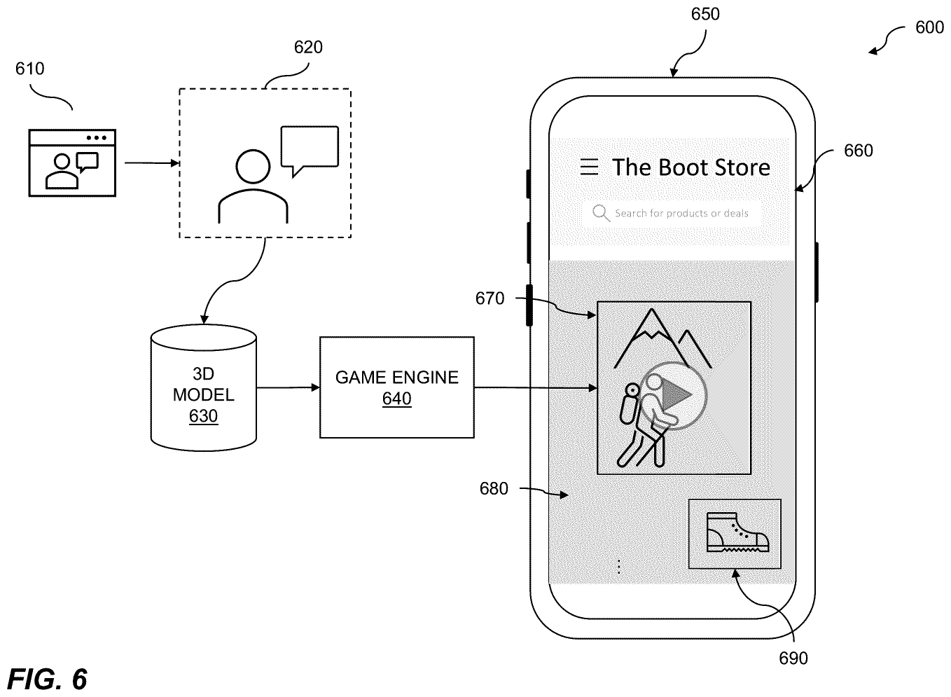

FIG. 6 is an example use of a synthesized photorealistic short-form video. The example 600 includes accessing a photorealistic representation of a first individual 610 from one or more media sources. In embodiments, viewer information can be collected that can be used to select a first individual for the synthesized host performance. The viewer information can include purchase history, view history, and metadata from one or more websites, social media platforms, and metaverse environments, including the website and metaverse hosting the viewing of the synthesized short-form video. The viewer information can be analyzed by an AI machine learning model and used to select a first individual that can appeal to the viewer to encourage further engagement and the purchase of highlighted items for sale in the synthesized short-form video.

In embodiments, the media sources can include one or more photographs, videos, livestream events, and livestream replays, including the voice of the first individual. In some embodiments, the photorealistic representation can include a 360-degree representation of the first individual. The first individual can comprise a human host that can be recorded with one or more cameras, including videos and still images, and microphones for voice recording. The recordings can include one or more angles of the human host and can be combined to comprise a dynamic 360-degree photorealistic representation of the human host. The voice of the human host can be recorded and included in the representation of the human host.

The example 600 includes isolating 620, using one or more processors, the photorealistic representation of the first individual 610 from within the one or more media sources, wherein the isolating is accomplished by machine learning. In embodiments, the media sources can include photographs, videos, livestream events, livestream replays, and recordings of a human host. The media sources can include the voice of the first individual. The isolating of the photorealistic representation 620 by machine learning can be accomplished by training a convolutional neural network (CNN) to recognize and classify images. As images are processed by the CNN, they are first converted into signal data and normalized. The images are then passed through a series of algorithms that filter and separate out unnecessary objects, such as background and non-human objects. This process is called segmentation. The CNN will then detect features in the remaining human image, such as facial features and body proportions, and classify them. Once the images have been classified, the CNN will assign them to specific categories. Thus, detailed physical information of the first individual can be extracted, categorized, and used to create a 3D model of the individual.

The example 600 includes creating a 3D model 630 of the first individual, wherein the 3D model is based on a game engine 640. As mentioned above and throughout, a game engine 640 is a set of software applications that work together to create a framework for developers to build and create video games. In embodiments, the isolated and categorized photorealistic images of the first individual can be used as input to a machine learning game engine that can build a detailed 3D model of the individual, including the voice of the individual extracted from the video and livestream recordings. The game engine 640 can include a Character Movement Component that provides common modes of movement for 3D humanoid characters, including walking, falling, swimming, crawling, and so on. These default movement modes are built to replicate by default and can be modified to create customized movements, such as skiing, skydiving, or riding a motorcycle, as part of a product demonstration. Facial features can be edited to appear more lifelike, including storing unique and idiosyncratic elements of a human face. Articles of clothing can be similarly edited to perform as they do in real life. Lighting presets can be used to place individual characters in photorealistic environments so that light sources, qualities, and shadows appear lifelike. Voice recordings can be used to generate dialogue with the same vocal qualities as the first individual. Volume, pitch, rhythm, frequency, and so on can be manipulated within the game engine to create realistic dialogue for the 3D model 630 of the first individual.

The example 600 includes synthesizing a first performance, by the first individual that was modeled 610, wherein the first performance is based on animation using the game engine 640. In embodiments, a game engine 640 can be used to generate a series of animated movements, including basic actions such as sitting, standing, holding a product, presenting a video or photograph, describing an event, and so on. Specialized movements can be programmed and added to the animation as needed. Dialogue can be added so that the face of the presenter moves appropriately as the words are spoken. The 3D model of the first individual can be used as the performer of the animation after the sequence of movements and dialogues have been decided. The result is a synthesized photorealistic performance by the selected first individual, combining the animation generated by the game engine 640 and the 3D model of the individual, including the voice of the individual. The synthesized performance can be generated as a short-form video 670 to be rendered directly to a webpage or social media platform or stored to be viewed later.

The example 600 includes rendering, to a viewer, a first short-form video 670, wherein the first short-form video includes the first performance that was synthesized and an ecommerce environment 680. In embodiments, the machine learning game engine 640 can be used to generate a short-form video 670 and play it for a viewer on a web page 660, as part of a livestream event, on a social media platform, etc. An ecommerce environment 680 can be rendered to include a virtual purchase cart and on-screen product cards 690 as part of the short-form video 670. A device 650 used to view the rendered synthetic host short-form video 670 can be an Over-the-Top (OTT) device such as a mobile phone, laptop computer, tablet, pad, or desktop computer, etc. The viewing of the short-form video can be accomplished using a browser or another application running on the device 650. A product card 690 can be generated and rendered on the device 650 used to view the short-form video 670. In embodiments, the product card 690 represents at least one product available for purchase on the website or social media platform hosting the short-form video or highlighted during the short-form video. Embodiments can include inserting a representation of a product for sale into the on-screen product card. Viewers can initiate and complete a purchase completely inside of the short-form video user interface, without being directed away from the currently playing video.

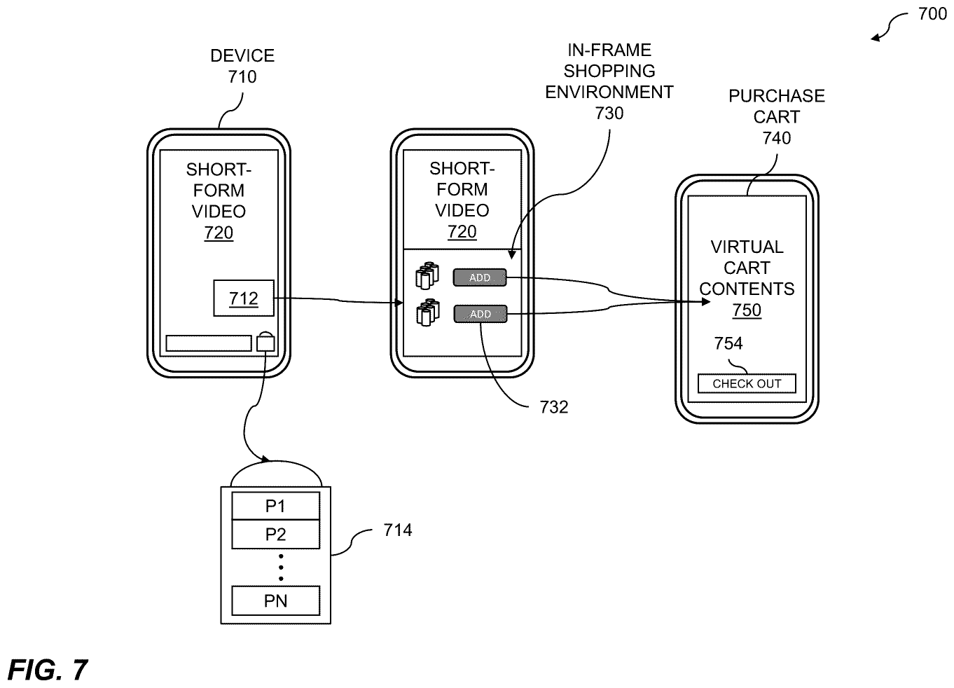

FIG. 7 illustrates an ecommerce purchase. As described above and throughout, a short-form video including a synthetic photorealistic host performance can be rendered to a viewer based on information collected about the viewer. The short-form video and the website or social network platform hosting the video can highlight one or more products available for purchase during the rendering of the video. An ecommerce purchase can be enabled during the short-form video using an in-frame shopping environment. The in-frame shopping environment can allow the viewer of the video chat to buy products and services during the rendering of the short-form video. The video chat can include an on-screen product card that can be viewed on a CTV or mobile device. The in-frame shopping environment or window can also include a virtual purchase cart that can be used by viewers as the short-form video plays.

The illustration 700 includes a device 710 displaying a synthesized photorealistic 3D short-form video 720. The device 710 can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. In some embodiments, the accessing the short-form video on the device can be accomplished using a browser or another application running on the device.

The illustration 700 includes generating and revealing a product card 712 on the device 710. In embodiments, the product card represents at least one product available for purchase while the short-form video plays. Embodiments can include inserting a representation of the first object into the on-screen product card 712. The on-screen product card can include product P1, product P2, and so on up to product PN. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. The product card can be inserted while the short-form video, including a synthetic host performance, is visible on the device. When the product card is invoked, an in-frame shopping environment 730 is rendered over a portion of the short-form video while the short-form video continues to play. This rendering enables an ecommerce purchase 732 by a user while preserving a continuous short-form video session 720. In other words, the user is not redirected to another site or portal that causes the short-form video to stop. Thus, viewers can initiate and complete a purchase completely inside of the short-form video user interface, without being directed away from the short-form video. Allowing the short-form video to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The illustration 700 includes rendering an in-frame shopping environment 730 enabling a purchase of the at least one product for sale by the viewer, wherein the ecommerce purchase is accomplished within the short-form video window. In embodiments, the short-form video can include a synthetic host performance in a split screen window with the user. The enabling can include revealing a virtual purchase cart 740 that supports checkout 754 of virtual cart contents 750, including specifying various payment methods, and application of coupons and/or promotional codes. In some embodiments, the payment methods can include fiat currencies such as United States dollar (USD), as well as virtual currencies, including cryptocurrencies such as Bitcoin. In some embodiments, more than one object (product) can be highlighted and enabled for ecommerce purchase. In embodiments, when multiple items 714 are purchased via product cards during the short-form video, the purchases are cached until termination of the video, at which point the orders are processed as a batch. The termination of the short-form video can include the user stopping the chat, the user exiting the video window, or the short-form video ending. The batch order process can enable a more efficient use of computer resources, such as network bandwidth, by processing the orders together as a batch instead of processing each order individually.

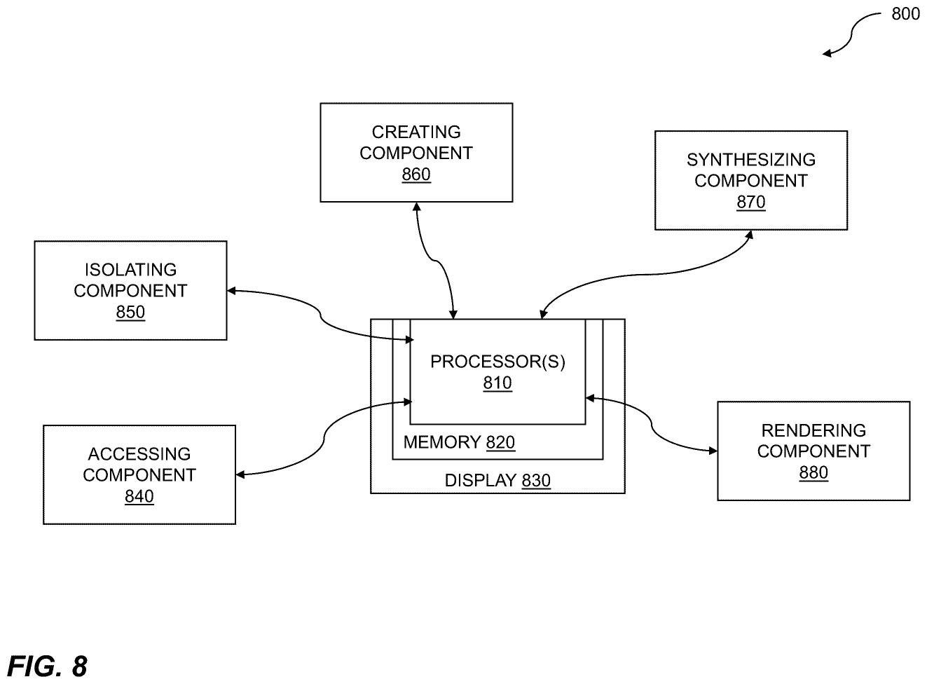

FIG. 8 is a system diagram 800 for a synthesized photorealistic short-form video. The system 800 can include one or more processors 810 coupled to a memory 820 which stores instructions. The system 800 can include a display 830 coupled to the one or more processors 810 for displaying data, video streams, videos, intermediate steps, instructions, and so on. In embodiments, one or more processors 810 are coupled to the memory 820 where the one or more processors, when executing the instructions which are stored, are configured to: access a photorealistic representation of a first individual from one or more media sources; isolate, using one or more processors, the photorealistic representation of the first individual from within the one or more media sources, wherein the isolating is accomplished by machine learning; create a 3D model of the first individual, wherein the 3D model is based on a game engine; synthesize a first performance, by the first individual that was modeled, wherein the first performance is based on animation using the game engine; and render, to a viewer, a first short-form video, wherein the first short-form video includes the first performance that was synthesized and an ecommerce environment.

The system 800 includes an accessing component 840. The accessing component 840 can include functions and instructions for providing video analysis for accessing a photorealistic representation of a first individual from one or more media sources. In embodiments, the selecting and accessing of a first individual can be based on information collected on the viewer of the short-form video. The viewer information can include purchase history, view history, and metadata. The media sources can include one or more videos, photographs, livestreams, livestream replays, and a 360-degree representation of the first individual. At least one source within the one or more media sources can include the voice of the first individual. In some embodiments, the first individual comprises a human host. The human host can be recorded with one or more cameras, including videos and still images taken from one or more angles. The human host recording can include a 360-degree representation of the first individual and the voice of the human host.

The accessing component 840 can include accessing a second performance by a second individual. The selection and accessing of a second performance by a second individual can be based on information collected on the viewer of the short-form video. The viewer information can include purchase history, view history, and metadata. The media sources can include one or more videos, photographs, livestreams, livestream replays, and a 360-degree representation of the second individual. At least one source within the one or more media sources can include the voice of the second individual.

The system 800 includes an isolating component 850. The isolating component 850 can include functions and instructions for isolating, using one or more processors, the photorealistic representation of the first individual from within the media source, wherein the isolating is accomplished by machine learning. In embodiments, the isolating of the photorealistic representation further comprises extracting physical information from the photorealistic representation of the first individual, including facial features and body proportions. The isolating and extracting of the first individual can be accomplished by machine learning. The isolating of the photorealistic representation by machine learning can be accomplished by training a convolutional neural network (CNN) to recognize and classify images of people. As images are processed by the CNN, they are first converted into signal data and normalized. The images are then passed through a series of algorithms that filter and separate out unnecessary objects, such as background and non-human objects. This process is called segmentation. The CNN will then detect features in the remaining human image, such as facial features and body proportions, and classify them. Once the images have been classified, the CNN will assign them to specific categories. Thus, physical information of the first individual can be extracted and used to create a 3D model of the individual.

The system 800 includes a creating component 860. The creating component 860 can include functions and instructions for creating a 3D model of the first individual, wherein the 3D model is based on a game engine. In embodiments, the isolated photorealistic images of the first individual can be used as input to a machine learning game engine that can build a detailed 3D model of the individual, including the voice of the individual extracted from the video and livestream recordings. The game engine can include a Character Movement Component that provides common modes of movement for 3D humanoid characters including walking, falling, swimming, crawling, and so on. These default movement modes are built to replicate by default and can be modified to create customized movements, such as skiing, scuba diving, or demonstrating a product. Facial features can be edited to appear more lifelike, including storing unique and idiosyncratic elements of a human face. Articles of clothing can be similarly edited to perform as they do in real life. Lighting presets can be used to place individual characters in photorealistic environments so that light sources, qualities, and shadows appear lifelike. Voice recordings can be used to generate dialogue with the same vocal qualities as the first individual. Volume, pitch, rhythm, frequency, and so on can be manipulated within the game engine to create realistic dialogue for the 3D model of the first individual.

The system 800 includes a synthesizing component 870. The synthesizing component 870 can include functions and instructions for synthesizing a first performance, by the first individual that was modeled, wherein the first performance is based on animation using the game engine. In embodiments, the synthesizing includes the voice of the first individual. In some embodiments, the synthesizing component can include synthesizing the second performance by the second individual, wherein the synthesizing is based on the game engine. In some instances, the synthesizing can replace, in the second performance, the second performance with the first individual, wherein the replacing is accomplished using machine learning. A game engine can be used to generate a series of animated movements, including basic actions such as sitting, standing, holding a product, presenting a video or photograph, describing an event, and so on. Specialized movements can be programmed and added to the animation as needed. Dialogue can be added so that the face of the presenter moves appropriately as the words are spoken. The 3D model of the host individual can be used as the performer of the animation after the sequence of movements and dialogues have been decided. The result is a synthesized performance by the selected host model, combining the animation generated by the game engine and the 3D model of the individual, including the voice of the individual.

The system 800 includes a rendering component 880. The rendering component 880 can include functions and instructions for rendering, to a viewer, a first short-form video, wherein the first short-form video includes the first performance that was synthesized and an ecommerce environment. In embodiments, the rendering includes inserting the first performance of the first individual in a metaverse representation. In some embodiments, the rendering can include a second short-form video based on the second performance by the second individual, wherein the second short-form video includes the ecommerce environment. In some embodiments, the rendering can include a second short-form video based on the second performance by the first individual, wherein the second short-form video includes the ecommerce environment.

The rendered synthesized host performance can be inserted into a metaverse environment. A metaverse is a virtual-reality space in which users can interact with a computer-generated environment and other users. It is accessed via the Internet using virtual reality (VR) and augmented reality (AR) technologies, which can be implemented to give a user a sense of virtual presence within the metaverse environment. Computer-generated images of objects, people, animals, buildings, backgrounds, and so on can be placed in the metaverse environment. Sounds can be recorded and projected into the metaverse environment as well, so that a user with a VR headset can see, hear, and speak to others within the metaverse environment. The VR headset allows 3D viewing and stereo sound so that the user experience is immersive. The synthesized host performance can be inserted into a metaverse virtual space so that a viewer with a VR headset can see and hear the host performance in a virtual 3D environment. The viewer can move around the synthesized host as the performance is played, seeing it from different angles, and so on.

The ecommerce environment can include one or more products for sale based on the information on the viewer, including purchase history, view history, and metadata. The first short-form video performance can include highlighting of the one or more products for sale for the viewer. The one or more products for sale can be represented in an on-screen product card. The ecommerce environment further comprises enabling an ecommerce purchase, within the ecommerce environment, of one or more products for sale, wherein the enabling includes a virtual purchase cart. The virtual purchase cart can be displayed within the first short-form video that was rendered. In some embodiments, the virtual purchase cart can cover a portion of the first short-form video as it plays. A device used to view the rendered synthetic host short-form video can be an Over-the-Top (OTT) device such as a mobile phone, laptop computer, tablet, pad, or desktop computer; etc. The viewing of the short-form video can be accomplished using a browser or another application running on the device. In embodiments, the product card represents at least one product available for purchase on the website or social media platform hosting the short-form video or highlighted during the short-form video. Embodiments can include inserting a representation of a product for sale into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or another suitable user action. When the product card is invoked, an in-frame shopping environment can be rendered over a portion of the short-form while the chat continues to play. This rendering enables an ecommerce purchase by a user while preserving a short-form video session. Thus, viewers can initiate and complete a purchase completely inside of the short-form video user interface, without being directed away from the currently playing video. Allowing the short-form video to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The system 800 can include a computer program product embodied in a non-transitory computer readable medium for video analysis, the computer program product comprising code which causes one or more processors to perform operations of: accessing a photorealistic representation of a first individual from one or more media sources; isolating, using one or more processors, the photorealistic representation of the first individual from within the media source, wherein the isolating is accomplished by machine learning; creating a 3D model of the first individual, wherein the 3D model is based on a game engine; synthesizing a first performance, by the first individual that was modeled, wherein the first performance is based on animation using the game engine; and rendering, to a viewer, a first short-form video, wherein the first short-form video includes the first performance that was synthesized and an ecommerce environment.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams, infographics, and flowchart illustrations depict methods, apparatus, systems, and computer program products. The elements and combinations of elements in the block diagrams, infographics, and flow diagrams show functions, steps, or groups of steps of the methods, apparatus, systems, computer program products and/or computer-implemented methods. Any and all such functions-generally referred to herein as a “circuit,” “module,” or “system”— may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video analysis comprising:
accessing a photorealistic representation of a first individual from one or more media sources;
isolating, using one or more processors, the photorealistic representation of the first individual from within the one or more media sources, wherein the isolating is accomplished by machine learning;
creating a 3D model of the first individual, wherein the 3D model is based on a game engine;
synthesizing a first performance, by the first individual that was modeled, wherein the first performance is based on animation using the game engine; and
rendering, to a viewer, a first short-form video, wherein the first short-form video includes the first performance that was synthesized and an ecommerce environment.

2. The method of claim 1 further comprising inserting the first performance of the first individual in a metaverse representation.

3. The method of claim 1 wherein the isolating the photorealistic representation further comprises extracting physical information from the photorealistic representation of the first individual.

4. The method of claim 1 further comprising accessing a second performance by a second individual.

5. The method of claim 4 further comprising synthesizing the second performance by the second individual, wherein the synthesizing is based on the game engine.

6. The method of claim 5 further comprising rendering a second short-form video based on the second performance by the second individual, wherein the second short-form video includes the ecommerce environment.

7. The method of claim 4 further comprising replacing, in the second performance, the second individual with the first individual, wherein the replacing is accomplished using machine learning.

8. The method of claim 7 further comprising rendering a second short-form video based on the second performance by the first individual, wherein the second short-form video includes the ecommerce environment.

9. The method of claim 1 wherein the first individual comprises a human host.

10. The method of claim 9 further comprising recording the human host with one or more cameras.

11. The method of claim 10 wherein the recording comprises a dynamic 360-degree representation of the human host.

12. The method of claim 10 wherein the recording includes a voice of the human host.

13. The method of claim 1 wherein the photorealistic representation includes a 360-degree representation of the first individual.

14. The method of claim 13 wherein the one or more media sources include one or more livestreams or livestream replays.

15. The method of claim 1 further comprising collecting information on the viewer.

16. The method of claim 15 wherein the first performance that was synthesized is based on the information on the viewer.

17. The method of claim 16 wherein the ecommerce environment includes one or more products for sale based on the information on the viewer.

18. The method of claim 1 further comprising enabling an ecommerce purchase, within the ecommerce environment, of one or more products for sale.

19. The method of claim 18 wherein the enabling the ecommerce purchase includes a virtual purchase cart.

20. The method of claim 19 wherein the rendering further comprises displaying, within the first short-form video that was rendered, the virtual purchase cart.

21. The method of claim 1 wherein the synthesizing includes a voice of the first individual.

22. The method of claim 1 wherein the rendering of the first short-form video includes stitching the first short-form video into a livestream.

23. A computer program product embodied in a non-transitory computer readable medium for video analysis, the computer program product comprising code which causes one or more processors to perform operations of:
accessing a photorealistic representation of a first individual from one or more media sources;
isolating the photorealistic representation of the first individual from within the one or more media sources, wherein the isolating is accomplished by machine learning;
creating a 3D model of the first individual, wherein the 3D model is based on a game engine;
synthesizing a first performance, by the first individual that was modeled, wherein the first performance is based on animation using the game engine; and
rendering, to a viewer, a first short-form video, wherein the first short-form video includes the first performance that was synthesized and an ecommerce environment.

24. A computer system for video analysis, comprising:
a memory which stores instructions;
one or more processors coupled to the memory wherein the one or more processors, when executing the instructions which are stored, are configured to:
access a photorealistic representation of a first individual from one or more media sources;
isolate the photorealistic representation of the first individual from within the one or more media sources, wherein the isolating is accomplished by machine learning;
create a 3D model of the first individual, wherein the 3D model is based on a game engine;
synthesize a first performance, by the first individual that was modeled, wherein the first performance is based on animation using the game engine; and
render, to a viewer, a first short-form video, wherein the first short-form video includes the first performance that was synthesized and an ecommerce environment.
